(19) United States
(12) Patent Application Publication
(10) Pub. No.: US 2011/0191985 A1
(43) Pub. Date: Aug. 11, 2011

(54) REPLACEABLE FLOOR PROTECTOR

(76) Inventor: Yechiel HIRTH, Lakewood, NJ (US)

(21) Appl. No.: 12/780,373

(22) Filed: May 14, 2010

Related U.S. Application Data
(60) Provisional application No. 61/302,967, filed on Feb. 10, 2010.

(51) Int. Cl. B60B 33/00

(52) U.S. Cl. 16/42 R

(57) ABSTRACT

A floor protector system suitable for being attached to the bottoms of furniture legs, includes a base having an attaching surface with one or more penetrating nail components integrally formed thereon and a general shape and size that matches the bottom surfaces of the furniture legs. A circumferential peripheral surface of the base has a retainer holding structure formed thereon, with a separate retainer having its own connection structure and configured to enable mechanical connection of the retainer to the base piece. A floor protector pad is attachable to the retainer and is made of material which is configured to allow furniture that has been provided with the floor protector system to easily slide on floor surfaces.

### CROSS-REFERENCE TO RELATED APPLICATION

This application is related to and claims priority to U.S. provisional patent application 61/302,967 filed Feb. 10, 2010, the entire contents of which are incorporated by reference herein in their entirety.

### BACKGROUND OF THE INVENTION

The present invention relates to floor protectors and, more particularly, to replaceable floor protectors for the legs of chairs and tables which are easier to install and replace and less likely to scratch floors, in the event that the replaceable floor protectors wear out or break.

It is well known to provide floor protectors on the bottoms of furniture legs to facilitate sliding movement of the furniture across the floor and, most importantly, to prevent damage to the floors from either chipped wood or metal in the furniture legs. Gliders are known to take a variety of forms, including the variety which includes an upper, base portion adapted to be attached to the leg of the furniture by nails, screws or the like, and lower portion which has a smooth, low friction bottom surface for contacting the floor. U.S. Pat. Nos. 6,869,052; 5,010,621; and 5,170,972 are representative of the prior art and their entire contents are incorporated by reference herein.

The mentioned U.S. Pat. No. 6,869,052 sets as its object, providing a flooring protector which can be fitted to the leg of a chair and easily replaced when worn, and which is uniquely designed to compensate for uneven chair or table legs. It further discloses two interconnected pieces, one which is intended to be permanently attached to the bottom of the furniture leg, and the other which can be screwed thereon.

Regardless, there are still shortcomings and drawbacks to the prior art approaches, including owing to the fact that they typically use either nails or screws or glues or a combination of such components to affix the base portion of the floor protector to the bottom of the furniture legs. Invariably, users require manual dexterity, including holding in their hands small nails, while banging them in with a hammer, or wielding a screwdriver or engaging in handling messy glues, tasks which are difficult and unpleasant for certain people.

Another difficulty with the prior art ensues from the fact that if these floor protectors break or wear down, their nails or screws can remain in the furniture and cause permanent damage to expensive wooden or stone floors and the like.

### SUMMARY OF THE INVENTION

It is an object of the present invention to provide a family of replaceable floor protectors for the legs of furniture, which are easier to install and less likely to cause damage to floors, even if any of their components become damaged or break outrightly.

It is yet another object of the invention to provide floor protectors in which the replaceable felt or plastic tabs are more easily and rapidly replaceable.

These and other objects of the invention are preferably realized by providing floor protectors which attach to the legs of chairs or tables and which include a first base component intended to be permanently affixed to the bottom of the chair and which is generally disc-shaped, with a flat, round surface which has a diameter approximating the diameter or cross-sectional area of the leg of the piece of furniture. This base component is affixable to the leg by a permanently installed or integrally formed nail in the base and several penetrating stab components. This base piece can be either pushed into the chair leg, or easily banged in, without having to hold a nail in one's hand, avoiding the possibility of injury to one's fingers.

The first permanently installed base piece has an outside periphery which is threaded to receive a second retainer piece which can be threaded thereon. The retainer has an interior space which supports a replaceable floor protector component made of felt, plastic or the like. Alternatively, the retainer piece with its floor protector may be mechanically snap connected to the base piece.

Other features and advantages of the present invention will become apparent from the following description of the invention which refers to the accompanying drawings.

### BRIEF DESCRIPTION OF THE DRAWINGS

FIG. 1 is an exploded view of a first embodiment of the invention.

FIG. 2 shows the first embodiment assembled.

FIG. 2A shows the first embodiment, with a square/rectangular nail component.

FIG. 3 shows a second embodiment of the invention.

FIG. 4 shows the base component of the floor protector in accordance with the first embodiment.

FIG. 5 shows the base component of the floor protector in accordance with the second embodiment.

FIG. 5A is a plan view of the top of the base component of FIG. 5.

FIG. 6 is a cross-section through the retainer component of the floor protector.

FIG. 7 shows another embodiment of the retainer component with the protector tab attached.

FIG. 8 is a cross-section through an assembled floor protector system.

FIG. 9 is a side view of FIG. 8.

FIG. 10 shows another embodiment of the base component.

FIG. 10A shows a side view of the base component of FIG. 10.

FIG. 11 shows the retainer adapted for the base embodiment of FIG. 10.

### DETAILED DESCRIPTION OF THE DRAWINGS

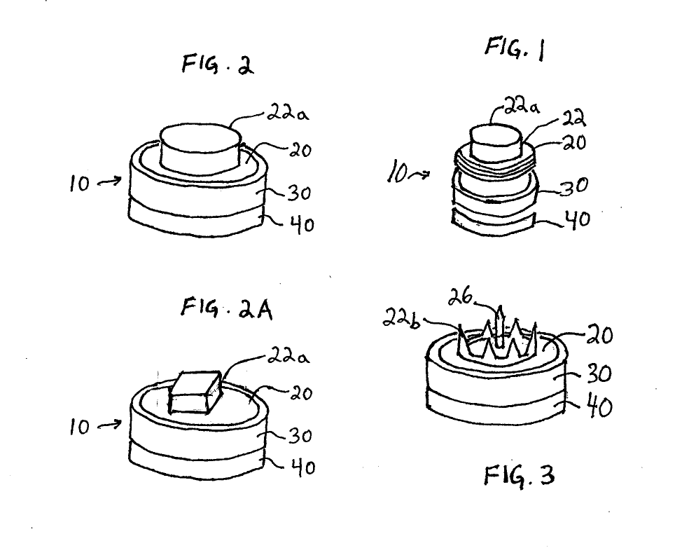

Referring to FIG. 1, in accordance with a first embodiment, the floor protector system 10 comprises a base 20 intended to be permanently affixed to the bottom of the leg of a piece of furniture, a retainer piece 30 and a protective pad 40. The protective pad 40 is either held within or adhesively attached to the retainer 30 which, in turn, is removably attached to the base 20. The assembled floor protector system 10 of FIG. 1 is shown in FIG. 2.

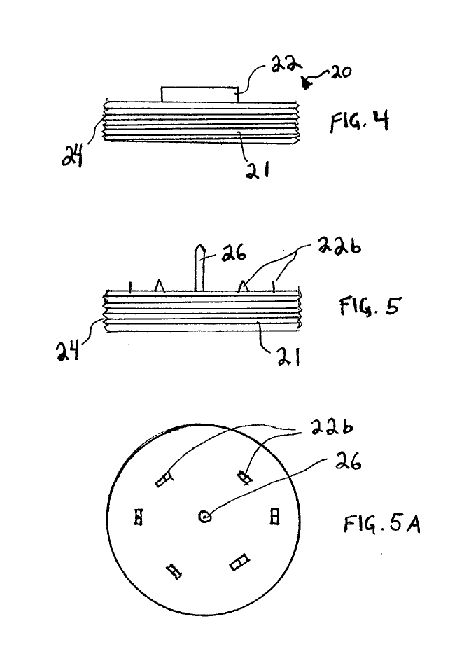

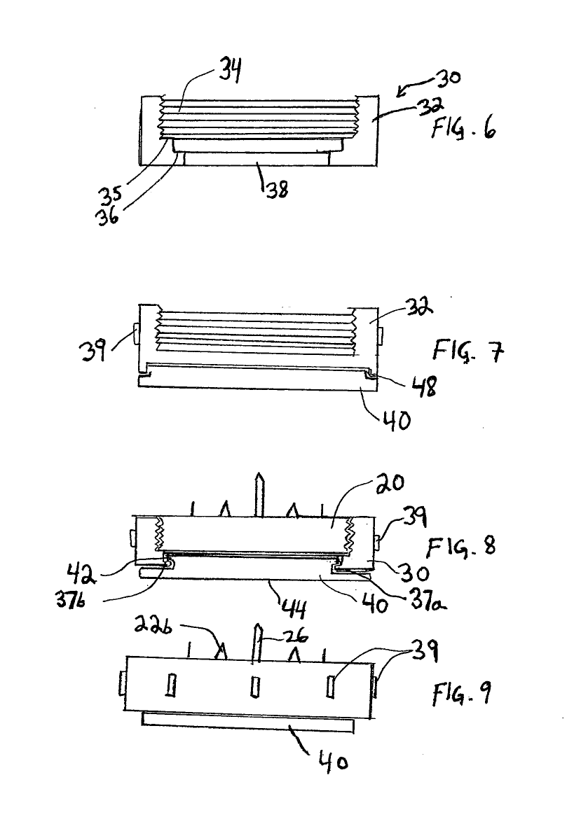

In FIG. 1, the base component 20 is attached to the bottom of a leg via a disc or ring-shaped hollow cylindrical nail 22 having a body 21 and a knife edge 22a, which is placed against the bottom of the leg and which is designed to be banged by a hammer into the bottom of a furniture leg, to be affixed to the furniture leg strongly and permanently. Referring to FIG. 4, the base 20 also has an outer peripheral surface which is formed with male threads 24.

Referring to FIGS. 3 and 5, in accordance with another embodiment, the base 20 comprises a series of sharp teeth 22b arranged circumferentially on the base, with a longer nail 26 at the center. The nail 26 allows the base 20 to be carefully placed, so that it touches the center of the bottom of a leg and then either pushed in by hand or banged in with a hammer. The teeth 22b, as well as the nail 26, are embedded or integrally formed in the base body 21 which can be formed of plastic or metal. Regardless, there are no nails to align from the bottom or to push through the base to hammer the base into the bottom of a furniture leg. Rather, the base can be forcefully pushed with a palm against the bottom of a chair, or just held from a distance by spaced fingers, while safely hammering the base, with only minimal, negligible risk of hitting the fingers. Alternatively, the chair leg can be banged against the floor to attach the base 20 thereto. FIG. 5A shows the top of the base and the locations of the teeth 22b and the single, longer nail 26.

Referring to FIG. 6, the retainer 30 is shown in cross-section to be generally circularly shaped with a peripheral wall or body 32 defining an interior which is internally threaded with female threads 34 along the top, sized to engage the male threads 24 on the base 20. A floor protector tab 40 made of felt or plastic material (or the like), with a bottom surface that has a very small coefficient of friction and which has a ledge 42 (FIG. 8), can be inserted from the top side of the retainer so that it protrudes at the bottom, the retainer itself being then screwed onto the base 20. Replacement of the floor protector pad 40 is exceedingly simple. All one needs do is unscrew the retainer, remove the old pad 40 and substitute a fresh, wholesome pad 40. The pad 40 can be made of somewhat compressible material which will automatically adjust the bottom surface 44 thereof to the shape of a floor and thereby adapt to a chair whose leg bottoms are somewhat inclined or uneven, i.e., not flat. The ledges 35 and 36 of the retainer 30 allow the pad 40 to be retained therein by engaging ledge 42. Preferably, the retainer also includes, as shown in FIG. 9, knurls 39, which allow more firm holding and turning the retainer to tightly affix it to the base 20. In FIG. 8, the protector 40 can be pressed into the well 48 and snapped into position (without adhesive) by engaging behind the resilient tabs 37a and 37b.

FIG. 7 shows the retainer 20 with its outer surface defining a well 48 for receiving an indented portion of the pad 40 therein by being held therein with adhesive or the like.

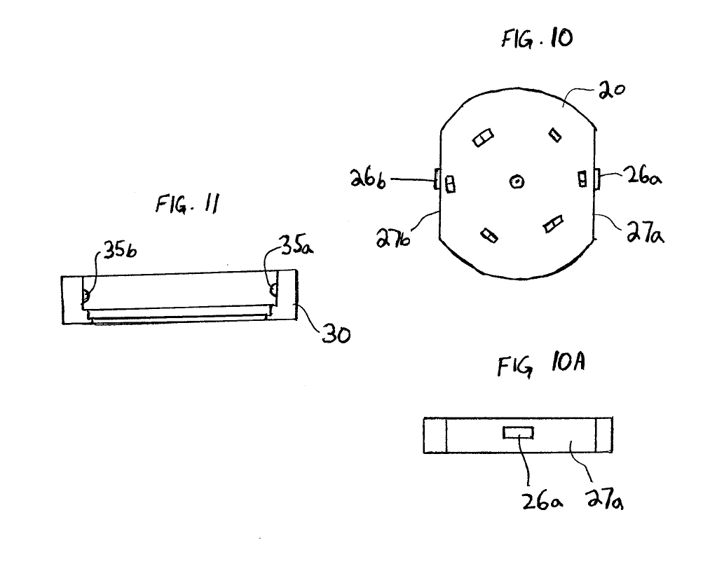

In the embodiment of FIG. 10, the base 20 has been modified so it does not include its male outside threads, those threads being replaced by two opposed flats 27a and 27b, on which lateral protrusions or tabs 26a and 26b have been formed. See also, FIG. 10A. With this arrangement, the retainer is formed without internal threads and, instead, is provided with snaps 35a and 35b, whereby it can be simply pushed onto and snapped into location, holding onto the tabs 26a and 26b. With the body of the retainer made of plastic, one can release the retainer by forcefully yanking it down or by utilizing a screwdriver or the like to force it down, to replace a worn pad 40.

As described above, the floor protector system 10 of the present invention dispenses with the need of having to hold small nails or screws in one hand and utilize tools, such as screwdrivers or hammers to bang in small sized nails. The retaining system allows the entire base to substitute for the nail head with the integral tabs or single nail being easily insertable. Moreover, even if the pad wears entirely down, or even if the retainer breaks away from the base, there is no risk of a nail head protruding from the bottom of a chair.

In accordance with other embodiments of the invention, the retainer and the pad may be integrally formed so that when the pad wears out, it is replaced together with the retainer. The base is capable of being made from plastic, metal or other composite materials.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A floor protector system suitable for being attached to the bottoms of furniture legs, the floor protector system comprising:
a base having an attaching surface with one or more penetrating nail components integrally formed thereon, and a surface area generally shaped and sized to match a bottom surface of the furniture legs;
a circumferential peripheral surface on the base, with a retainer holding structure formed thereon;
a retainer with a connection structure configured to enable mechanical connection of the retainer to the base; and
a floor protector pad attachable to the retainer and made of a material which is configured to allow its sliding on a floor surface.

2. The floor protector system of claim 1, wherein the retainer holding structure comprises external threads formed on the peripheral surface of the base.

3. The floor protector system of claim 2, wherein the connection structure of the retainer comprises internal threads engageable with the external threads of the base.

4. The floor protector system of claim 1, wherein the one or more nail components comprises a ring-shaped protrusion extending from the base and terminating in a knife edge.

5. The floor protector system of claim 1, wherein the penetrating one or more nail components comprises at least one nail disposed centrally on the base.

6. The floor protector system of claim 5, wherein the one or more nail components comprises a plurality of teeth arranged around the nail.

7. The floor protector system of claim 1, wherein the one or more nail components comprises a square-shaped protrusion extending from the base and terminating in a knife edge.

8. The floor protector system of claim 1, wherein the floor protector pad is shaped to be partially held inside the retainer and partially protrude from the retainer through an opening formed in the retainer.

9. The floor protector system of claim 1, wherein the retainer comprises a knurled peripheral surface.

10. The floor protector system of claim 1, wherein the retainer holding structure of the base comprises opposed, flattened sides with projections extending laterally from the flat sides and wherein the connection structure on the retainer comprises snaps which are mechanically shaped to snap connect with the protrusions on the base.

11. The floor protector system of claim 1, wherein the retainer comprises a well and a portion of the floor protector pad is located within the well of the retainer.

12. The floor protector system of claim 1, wherein the base is made of metal and the retainer is made of synthetic material.
